(19) United States
(12) Patent Application Publication
(10) Pub. No.: US 2002/0084710 A1
(43) Pub. Date: Jul. 4, 2002

(54) Line start permanent magnet motor

(76) Inventors: Andrew Worley, Eastbourne (GB); Kevin Black, Eastbourne (GB); Simon Paul Purbrook, Seaford (GB)

Correspondence Address: Gregory R. Stephenson, HAMILTON SUNDSTRAND CORPORATION, Intellectusl Property Dept., Mail Stop 1-1-BC18, Windsorl Locks, CT, 06096-1010, US

(21) Appl. No.: 09/750,578

(22) Filed: Dec. 28, 2000

(51) Int. Cl. H02K 1/27

(52) U.S. Cl. 310/156.23

(57) ABSTRACT

Difficulties in self-starting a permanent magnet motor are eliminated in a structure including a stator with a rotor journalled within the stator for rotation about an axis. The rotor includes a body of ferromagnetic material having a nominally cylindrical peripheral surface concentric with the axis. Permanent magnets are located on the peripheral surface to define equally angularly spaced magnetic poles with alternating ones of the poles being of opposite polarity. A thin, hollow cylinder formed of a good electrically conducting material is disposed on the body to sandwich the magnets against the peripheral surface of the body and provides a situs for the generation of localized induced electrical current which generates magnetic fields that react with rotating magnetic fields in the stator to start the motor from a dead stop without the need for position sensors or controlled electronics.

### FIELD OF THE INVENTION

This invention relates to electric motors, and more particularly, to a permanent magnet motor that is capable of self starting when operated directly on line.

### BACKGROUND OF THE INVENTION

Permanent magnet motors are typically unable to operate without elaborate controls because they cannot be started when connected directly to the line. Thus, they typically employ rotor position transducers and control electronics in order to start. These components quite clearly add to both the cost and the complexity of the motor system.

As one means of avoiding position transducers and control electronics, while providing for a direct on-line starting performance, squirrel cage rotor bars and magnets have been employed and located on the surface of the rotor of the motor. The magnets are located in spaces between the conducting bars on the rotor. This produces two disadvantages. Firstly, the rotor bars effectively create slots in the surface of the magnets, thereby reducing the effectiveness of the operation of the permanent magnet motor. Secondly, the magnets that are located on the surface of the rotor reduces motor inductance, thereby reducing the effectiveness of the motor operation as driven by induction. As a consequence, poor motor efficiency results.

Another conventional alternative includes a motor having a rotor with squirrel cage rotor bars located on or near the surface of the rotor and magnets buried within the rotor. Although this construction provides reasonable performance as regards efficiency of both induction and permanent magnet induced operation, the construction is relatively difficult to manufacture. This is due to the requirement of properly locating the magnets in slots within the rotor itself.

The present invention is directed to overcoming one or more of the above problems.

### SUMMARY OF THE INVENTION

It is the principal object of the invention to provide a new and improved permanent magnet motor. More specifically, it is an object of the invention to provide such a motor that is capable of starting when connected directly on-line and without the need for the use of rotor position transducers and/or control electronics.

An exemplary embodiment of the invention achieves the foregoing objects in a self-starting permanent magnet motor that includes a stator with a rotor journalled within the stator for rotation about an axis. The rotor includes a body of ferromagnetic material having an approximately cylindrical peripheral surface concentric with the axis. Permanent magnets are located on the peripheral surface so as to define “n” equally angularly spaced magnetic poles with alternating polarity. “n” is an even integer of at least two. A thin, hollow cylinder is disposed on the body to sandwich the magnets against the peripheral surface. The hollow cylinder is formed of a good electrically conducting material.

In one embodiment, the structure further includes corrosion resistant sealing end pieces at opposite ends of the body and a corrosion resistant hollow cylinder disposed on the body to sandwich the conducting cylinder against the magnets. The hollow corrosion resistant cylinder is sealed to both of the end pieces.

An embodiment of the invention contemplates that the sides of the poles be circumferentially spaced from one another and that the spaces thus formed are filled with a rotor forming material. In one embodiment, the rotor forming material is part of the ferromagnetic body while in another embodiment, the rotor forming material is a potting compound.

In a highly preferred embodiment of the invention, each of the magnets is made of plural pieces and each in turn has a flat surface. The peripheral surface of the body has a plurality of flats against which respective ones of the plurality of magnet pieces are abutted.

Other objects and advantages will become apparent from the following specification taken in connection with the accompanying drawings.

### DESCRIPTION OF THE DRAWINGS

FIG. 1 is a sectional view of a self-starting permanent magnet motor made according to the invention;

FIG. 2 is a partially schematic, sectional view taken approximately the line 2-2 of FIG. 1;

FIG. 3 is an enlarged, fragmentary, sectional view of part of the periphery of the rotor of the motor;

FIG. 4 is a sectional view of a modified embodiment of a rotor made according to the invention;

FIG. 5 is a sectional view of the modified embodiment taken approximately along the line 5-5 of FIG. 4; and

FIG. 6 is an enlarged, fragmentary view of the rotor periphery of the embodiment of FIGS. 4 and 5.

### DESCRIPTION OF THE PREFERRED EMBODIMENT

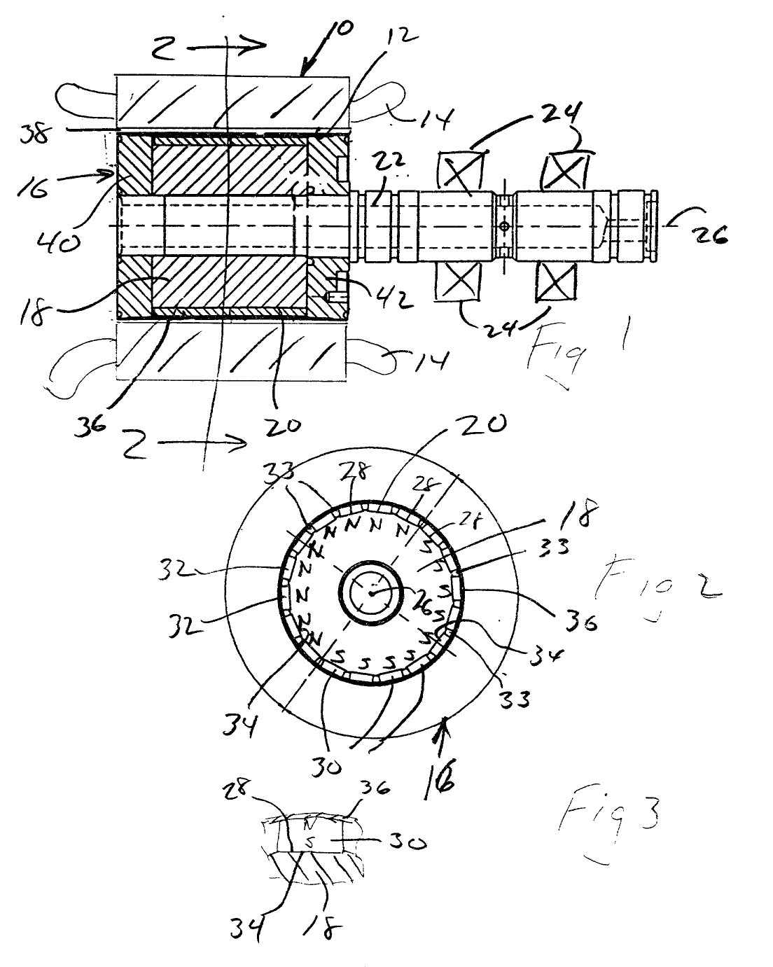

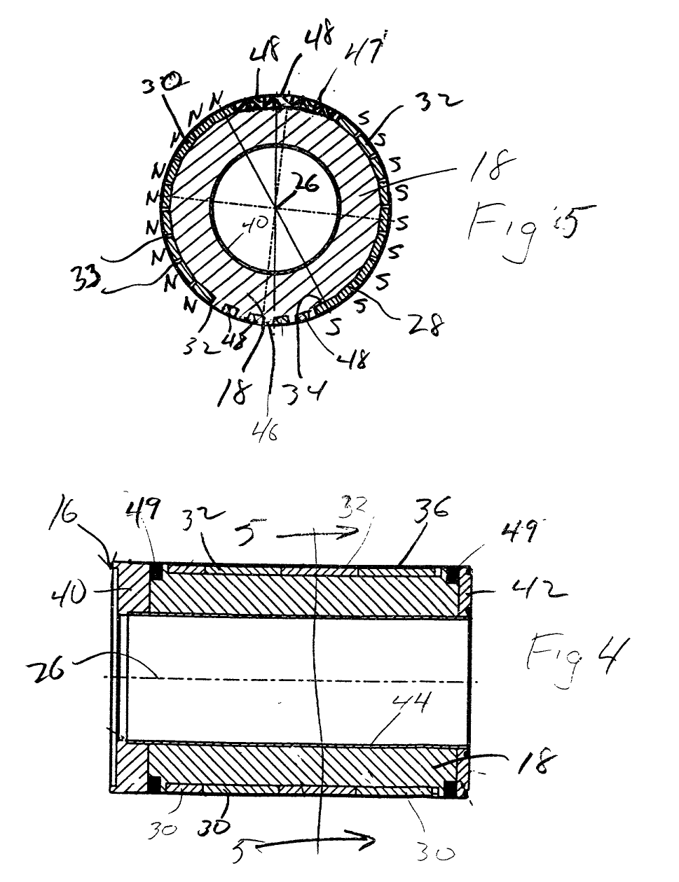

Referring to FIG. 1, an exemplary embodiment of a permanent magnet motor is illustrated and is seen to include a stator, generally designated 10, having a central opening 12 and windings, only the end turns 14 of which are shown. The stator 10 may be of conventional construction and will be energized by placing an alternating current voltage across the windings, including the end turns 14. A rotor, generally designated 16, includes a body of ferromagnetic material 18. As seen in FIG. 2, the body 18 has a nominally cylindrical outer surface 20. The body 18 is mounted on a shaft 22 of any desired configuration and in turn is journalled as by bearings schematically shown at 24 for rotation about an axis 26. The peripheral surface 20 of the body 18 is concentric with the axis 26.

Turning again to FIG. 2, the peripheral surface 20 of the body 18 includes a series of flats 28 that extend longitudinally along the length of the body 18, that is, in parallel relationship to the axis 26. A series of permanent magnet segments or pieces 30 and 32 have flat sides 34 which are abutted against the flats 28 and held in place by any suitable means. If desired, a thin layer of adhesive (not shown) may be used for the purpose. It will be observed that the magnets 30 extend about a circumferential extent of 180° of the rotor 16 as do the magnets 32, although lesser circumferential extents can be used. The magnets 32 have their north poles located radially inwardly while the magnets 30 have their south poles located radially inwardly.

Those skilled in the art will thus recognize that the rotor illustrated in the drawings is a two pole rotor having one north pole and one south pole, the north pole being defined by the magnets 30 and the south pole being defined by the magnets 32. Of course, a greater number of poles could be employed as desired so long as the poles are equally angularly spaced about the periphery of the rotor 16. In general, the number of poles “n” will be an even integer, i.e., two, four, six, etc.

Sandwiching the magnets 30, 32 against the body 18 is a thin can or sleeve 36 in the configuration of a hollow cylinder made of a good electrical conductor. Copper is preferred because of its relatively low cost when compared to other good conducting materials. However, other good conductors, including aluminum, silver, etc. could be used where their particular characteristics provide a useful function in the apparatus.

As usual, a small air gap 38 exists between the stator 10 and the rotor 16.

The rotor may also include a pair of end pieces 40 and 42 which abut opposite ends of the body 18 and which are axially spaced along the axis 26. The hollow cylinder 36 is supported by the periphery of the end pieces 40 and 42. The end pieces 40 and 42 will be formed of a relatively poor magnetic conductor such as stainless steel.

In an alternate embodiment, the end pieces 40 and 42 are formed of a corrosion resistant material and a second hollow cylinder 43 (FIG. 6) is fitted over the outside of the first hollow conducting cylinder 36. This second hollow cylinder 43 is also formed of a corrosion resistant material and is sealed to the end pieces 40 and 42 hence creating a sealed environment for the permanent magnets 30, 32 and the hollow conducting cylinder 36.

An alternate embodiment is illustrated in FIGS. 4-6. Like components are given like reference numerals. In this embodiment, it will be seen that not only are the magnets 30, 32 forming each of the two poles in separate pieces spaced circumferentially about the axis 26, they may also be formed in separate pieces extending along the length of the axis 26 as well. Again, flats 28 are employed on the rotor body 18 as well as flat surfaces 34 on the magnets 30, 32. The rotor may also be provided with a corrosion resistant inner sleeve 44 sealed and welded to the end pieces 40, 42 to completely encapsulate the rotor body.

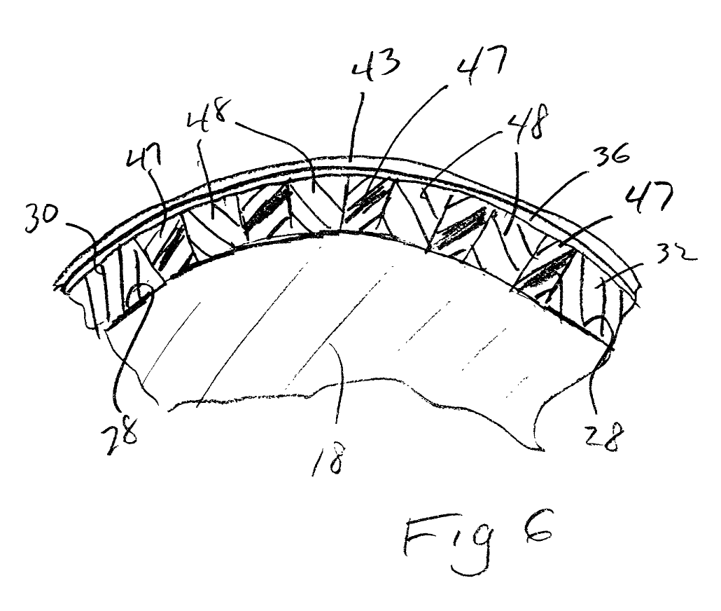

In this embodiment the circumferential extent of each of the two poles is but 125° for the FIG. 4 embodiment, rather than 180°. Again, the circumferential extent of the poles may be at other angles. Thus, spaces 46, 47 exist between the edges of the two poles and the spaces 46 are filled with rotor forming material. As seen in the lower part of FIG. 5, the rotor forming material filling the space 46 is nothing more than a continuation of the ferromagnetic material of the body 18, that is, formed by a ridge on the cylindrical peripheral surface of the body 18. The purpose is to enhance the structural strength of the rotor but where such additional strength is not required, the material can be omitted. At the top of FIG. 5, the space 47 may alternatively be filled with a potting compound such as an appropriate epoxy resin. In general, both of the spaces 46, 47 will be filled with the same material, i.e., ferromagnetic material or potting compound.

In one alternative embodiment, axial grooves or slots are formed in the material filling the spaces 46, 47. Electrically conducting bars or rods 48 are located in the grooves thus formed. The bars 48 are joined to electrically conducting rings 49 at opposite ends of the rotor body 16.

This construction can be employed as an alternative to the use of the hollow conducting cylinder 36 or in addition to it.

In operation, these embodiments operate in essentially the same way. When an alternating current voltage is applied to the stator 10, a rotating magnetic field is induced by the stator 10. This rotating magnetic field, in turn, induces localized electrical currents within the hollow cylinder 36 and/or the conducting bars 48 which react with the rotating magnetic field in the stator 10 to initiate rotation of the rotor 16 within the stator 10. In other words, magnetic fields generated by induced current within the hollow cylinder 36 and/or bars 48 reacting with the rotating magnetic field in the stator 10 generates a torque to initiate rotation of the rotor 16. This torque accelerates the rotor 16 toward synchronous speed.

As the rotor 16 gains speed, the interaction between the rotating magnetic field in the stator 10 and the magnets 30, 32 increases to further accelerate the rotor 16. When synchronous speed is achieved, there will be no induced current flowing in the hollow cylinder 36 and/or bars 48 because of a lack of relative rotation and any losses that might otherwise be experienced due to such induced current cease as long as synchronous speed is maintained. At this point, the rotor 16 is driven solely as a result of the interaction of the rotating magnetic field in the stator 10 with the magnets 30, 32.

From the foregoing, it will be appreciated that a motor made according to the invention solves the problems listed previously. Losses are minimized because conductors on the rotor, namely the hollow cylinder 36 and/or bars 48, are not effective to form notches in the magnetic poles which impede efficiency. At the same time, it is not necessary to locate the magnets 30, 32 well within the body 18 so that construction problems, and the costs thereof are eliminated. Similarly, because the start up torque is supplied solely by induced current within the hollow cylinder 36 and/or bars 48, there is no need for position sensors or electronic controllers to be used during start up.

A motor made according to the invention is ideally suited for any of a variety of uses requiring self-starting permanent magnet motors. In applications where corrosion resistance is desired, as, for example, in pumps or the like, the use of non-corroding material in forming the end pieces 40, 42 and the addition of a second hollow cylinder of non-corroding material located outside the conducting cylinder and sealed to the end pieces 40, 42 readily prevent damage to the rotor that might otherwise be caused by contact with corrosive materials.

The hollow cylinder 36 can be made sufficiently thin so as to not effectively increase the air gap 38 between the rotor 16 and the stator 10 which would cause the loss of efficiency so that a high efficiency, self-starting alternating current permanent magnet motor is provided. A wall thickness of 1.2 mm for the hollow cylinder 36 has proved to be effective.

To avoid losses due to an enlargement of the air gap, the hollow corrosion resistant cylinder should also have a thin wall, for example, 0.56 mm when 316L stainless steel is employed.

I claim:

1. A self starting permanent magnet motor, comprising a stator; and
a rotor journalled within said stator for rotation about an axis, said rotor including
a body of ferromagnetic material located on said axis and having a nominally cylindrical peripheral surface concentric with said axis;
permanent magnets located on said peripheral surface defining “n” equally angularly spaced magnetic poles with alternating ones of said poles being of opposite polarity and “n” being an even integer of at least 2; and
a thin, hollow conducting cylinder disposed on said body sandwiching said magnets against said peripheral surface, said hollow cylinder being formed of good electrically conducting material.

2. The motor of claim 1 further including sealing end pieces at opposite ends of said body and a second hollow cylinder sealed to both said end pieces.

3. The motor of claim 2 wherein said second hollow cylinder and both said end pieces are formed of corrosion resistant material.

4. The motor of claim 1 wherein said hollow conducting cylinder is formed of copper.

5. The motor of claim 1 wherein the sides of said poles are circumferentially spaced from one another, and spaces therebetween are filled with rotor forming material.

6. The motor of claim 5 wherein said rotor forming material is part of said body.

7. The motor of claim 5 wherein said rotor forming material is a potting compound.

8. The motor of claim 5 wherein conducting bars are located in axial slots or grooves in said rotor forming material and connected at either end to a conducting ring.

9. The motor of claim 1 wherein each of said magnets is made of plural pieces, each in turn having a flat surface, and said peripheral surface has a plurality of flats against respective ones of which the plural pieces are abutted.

10. A self starting permanent magnet motor, comprising
a stator; and
a rotor journalled within said stator for rotation about an axis, said rotor including
a body of ferromagnetic material having a generally cylindrical peripheral surface concentric with said axis;
permanent magnets located on said peripheral surface defining “n” equally angularly spaced magnetic poles with alternating ones of said poles being of opposite polarity and “n” being an even integer of at least 2; and
a thin, hollow, electrically conducting cylinder disposed on said body sandwiching said magnets against said peripheral surface.
